(19) United States
(12) Patent Application Publication
(10) Pub. No.: US 2026/0043425 A1
(43) Pub. Date: Feb. 12, 2026

(54) RAIL GRIPPING

(71) Applicant: Robert Duane Butler, Anaconda, MT (US)

(72) Inventor: Robert Duane Butler, Anaconda, MT (US)

(21) Appl. No.: 18/915,046

(22) Filed: Oct. 14, 2024

Related U.S. Application Data
(60) Provisional application No. 63/681,238, filed on Aug. 9, 2024.

(51) Int. Cl. F16B 2/18; F41A 23/18

(52) U.S. Cl. CPC F16B 2/185; F41A 23/18

(57) ABSTRACT

A gripping system includes a clamp base, a clamp, a toggle and a latch. The clamp base has a flange and a web extending from a proximal end at the foot to a distal end. The clamp is coupled with the clamp base for limited translation relative thereto. The toggle has a central, forked portion, a seat and one or more camming pivots and is coupled with the clamp so as to pivot about a first axis. The latch is coupled with the toggle so as to pivot about a second axis spaced apart from the first axis and has one or more feet contacting the clamp and a tongue received through the forked portion for selective placement against the seat of the toggle.

### CROSS-REFERENCE TO RELATED APPLICATIONS

The disclosure claims the benefit of and incorporates herein by reference in its entirety U.S. Provisional Application 63/681,238, pending, filed 9 Aug. 2024 and titled ‘GUN HANGING/LATCHING SYSTEM’.

### SUMMARY

The disclosure describes a gripping system. The gripping system includes a clamp base, a clamp, a toggle and a latch. The clamp base has a flange and a web extending from a proximal end at the foot to a distal end. The clamp is coupled with the clamp base for limited translation relative thereto. The toggle has a central, forked portion, a seat and one or more camming pivots and is coupled with the clamp so as to pivot about a first axis. The latch is coupled with the toggle so as to pivot about a second axis spaced apart from the first axis and has one or more feet contacting the clamp and a tongue received through the forked portion for selective placement against the seat of the toggle.

The disclosure also describes a second gripping system. The second gripping system includes a clamp base, a clamp, a toggle, a knuckle and a fastener. The clamp base has a flange and a web extending from a proximal end at the flange to a distal end. The clamp coupled is coupled with the clamp base for limited translation relative thereto. The toggle has a central, forked portion, one or more camming pivots and a seat and is coupled with the clamp so as to pivot about a first axis. The knuckle has a body and first and second dowel arms extending therefrom. The toggle further includes a yoke cradling the first and second dowel arms. The fastener is received through a central through-hole in the body of the knuckle, through the toggle, through the latch and into a central bore of the clamp base. At a first pivot angle, the toggle is configured to space the clamp from the knuckle by a first distance and, at a second pivot position, the toggle is configured to space the clamp from the knuckle by a second distance greater than the first distance.

Further, the disclosure describes a third gripping system. The third gripping system includes a clamp base, a clamp, a toggle and a latch. The clamp base has a flange and a web extending from a proximal end at the foot to a distal end. The clamp is coupled with the clamp base for limited translation relative thereto. The toggle has a central, forked portion, a seat and one or more camming pivots and is configured for coupling with the clamp so as to pivot about a first axis. The latch is configured for coupling with the toggle so as to pivot about a second axis spaced apart from the first axis. Further, the latch has one or more feet configured to translate relative to the clamp and a tongue configured for receipt through the forked portion and selective placement against the seat of the toggle.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 illustrates a perspective view of an example rail grip system in a locked state.

FIG. 2 illustrates a perspective view of an example rail grip system in an unlocked state.

FIG. 3 illustrates an exploded front view of the example rail grip system of FIGS. 1 & 2.

FIG. 4 illustrates an exploded front, bottom view of the example rail grip system of FIGS. 1-3.

FIG. 5 illustrates an exploded front, top view of the example rail grip system of FIGS. 1-4.

FIG. 6 illustrates an exploded, right, rear perspective view of the example rail grip system of FIGS. 1-5.

FIG. 7 illustrates an exploded, front, top view of example components suitable for use in association with the example rail grip system of FIGS. 1-5.

FIG. 8 illustrates an exploded, front, bottom view of the example components of FIG. 7.

FIG. 9 illustrates an example rail grip system in use with an example firearm.

### DETAILED DESCRIPTION

The following detailed description illustrates embodiments of the present disclosure and manners by which they can be implemented. Although the best mode of carrying out the present disclosure has been set forth herein, those of ordinary skill in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Many times, it is desirable for a person to be able to secure an object in an unobstructed, easy-to-access location such as on a countertop, a rack system or on a wall. In particular, with firearms, it may be desirable to prevent unauthorized removal of the object. Known mechanisms for storing objects such as firearms are not secure and are difficult to disengage.

Embodiments of the disclosure provide a gripping or latching system suitable for use in any of a variety of methods for securing an object such as a firearm.

Embodiments of the disclosure substantially eliminate, or at least partially address, problems in the prior art, enabling secure mounting of an object such as a firearm to a surface as a wall, rack system, gun cabinet, or any other similar environment. Disclosed gripping systems may utilize a standarized rail system provided to a firearm or other object and allow for ease of access to the object with a simple throw of a lever to unlock it from the system.

Additional aspects, advantages, features and objects of the disclosure will be made apparent from the drawings and the detailed description of the illustrative embodiments construed in conjunction with the appended claims that follow.

It will be appreciated that features of the disclosure are susceptible to being combined in various combinations without departing from the scope of the disclosure as defined by the appended claims.

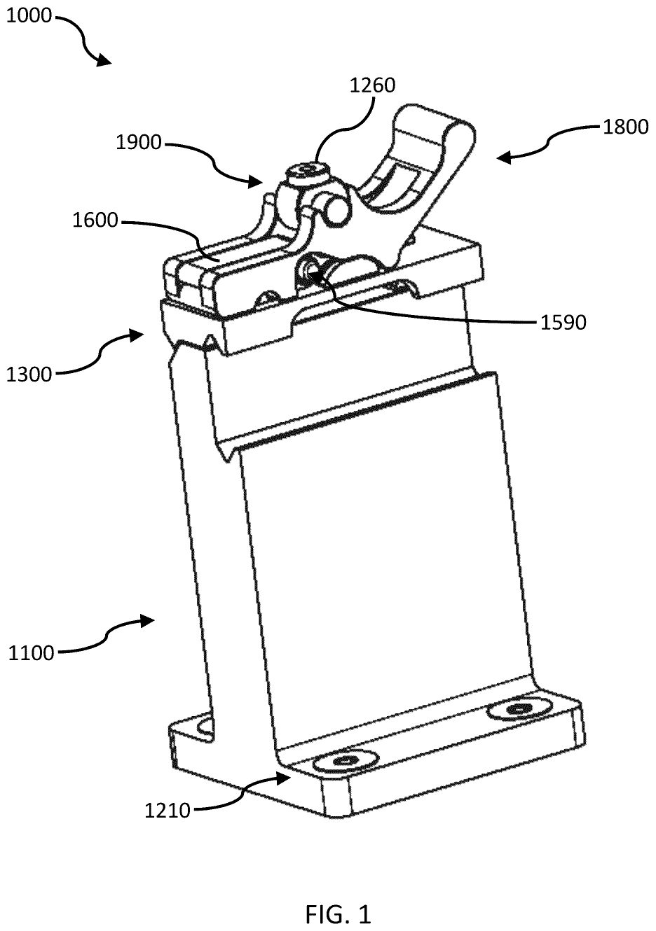

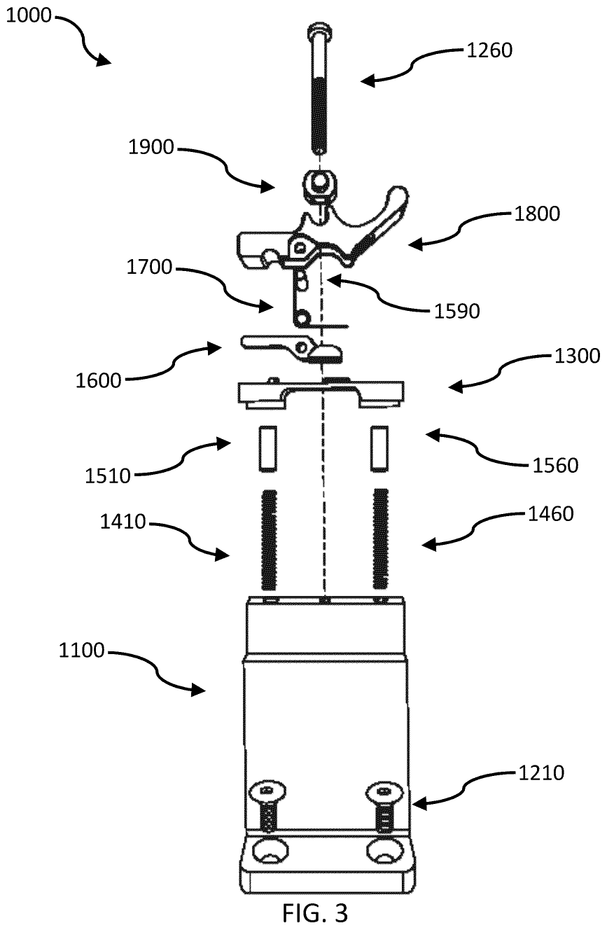

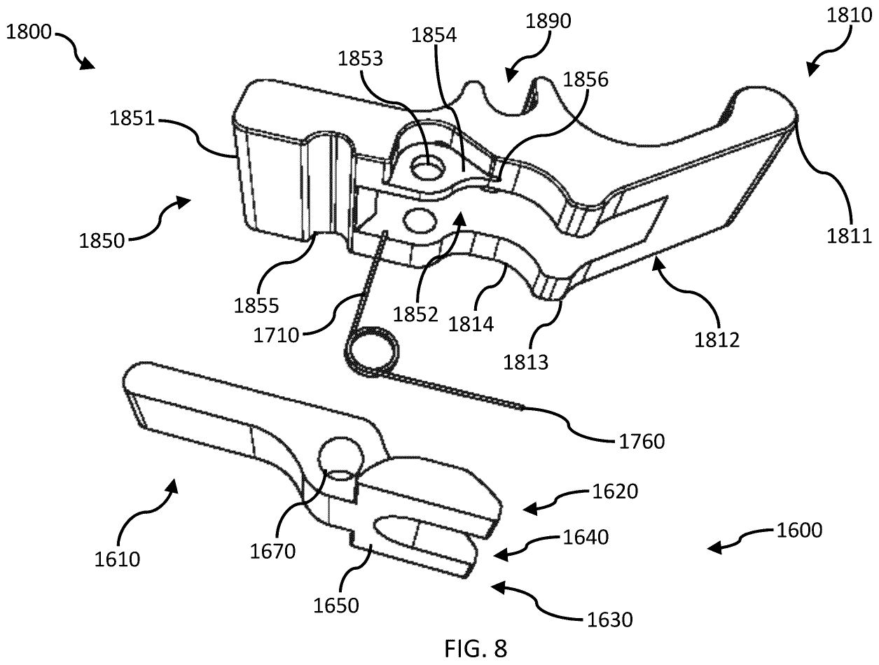

FIGS. 1-8 illustrate an example latching or gripping system 1000 which may be suitable to grip or latch to a rail such as that often provided to a firearm. Gripping system 1000 includes a clamp base 1100, a clamp 1300, a latch 1600, a toggle 1800 and a knuckle 1900. Gripping system 1000 may further include a number of fasteners 1200, a number of pins or dowels 1500 (FIGS. 3-5) and a number of resilient members 1400 and 1700.

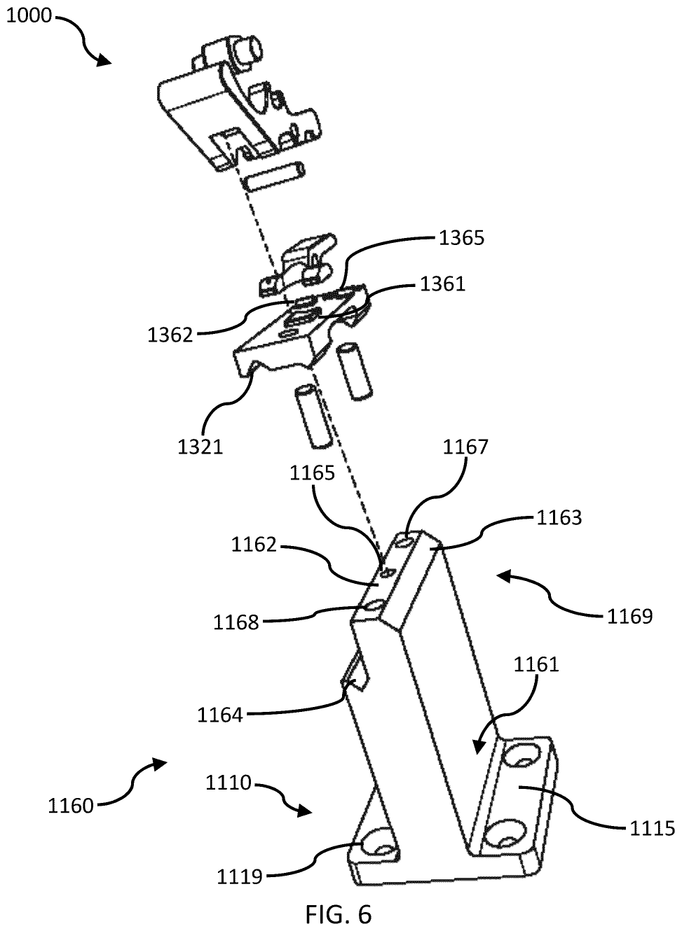

Clamp base 1100 has a foot or flange 1110 (FIG. 6) with an upper surface 1115 and a lower surface (not visible) suitable for placement against a support surface. A leg or web 1160 projects or extends from a proximal end 1161 at flange upper surface 1115 to a distal end 1169. A number of mounting holes 1119 extend between the lower surface and upper surface 1115 and are suitable for receiving mounting hardware 1210 such as a plurality of fasteners. Example mounting hardware may include but is not limited to hex drive flat head screws.

Distal end 1169 includes an upper surface 1162 and an oblique or chamfered surface 1163 adjoined or adjacent to the upper surface. Chamfered surface 1163 may adjoin or extend from upper surface 1162 at any of a variety of angles suitable for cooperating with a corresponding, inner chamfered surface of clamp 1300. A central bore 1165 penetrates through upper surface 1162 into web 1160. A first side bore 1167 adjacent a first side of the web 1160 penetrates through upper surface 1162 and into web 1160 in a direction approximately parallel with central bore 1165. A second side bore 1168 adjacent a first side of web 1160 also penetrates through upper surface 1162 and into web 1160 in a direction approximately parallel with central bore 1165. With an approximately parallel relationship between the directions of side bores 1167, 1168 and central bore 1165, angles between the bores are sufficiently small so as to enable unimpeded motion of coupled components along the respective directions without binding between bores and any associated dowels.

Web 1160 may further include an upward-opening groove 1164 intermediate the proximal and distal ends 1161 and 1169 and directed towards distal end 1169. Surfaces of upward-opening groove 1164 may be formed at any of a variety of angles to a longitudinal axis of web 1160 and/or to one another so as to securely grip a rail such as a rail of a firearm. Clamp base 1100 may be formed from any of a variety of rigid, durable materials including but not limited to forged metal, forged aluminum, injection molded plastic or rubber.

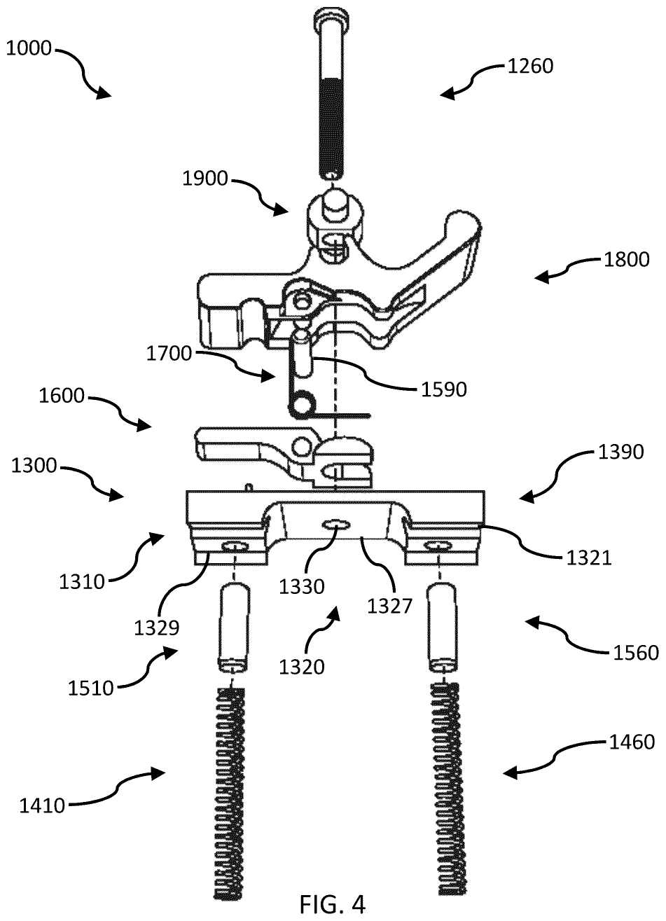

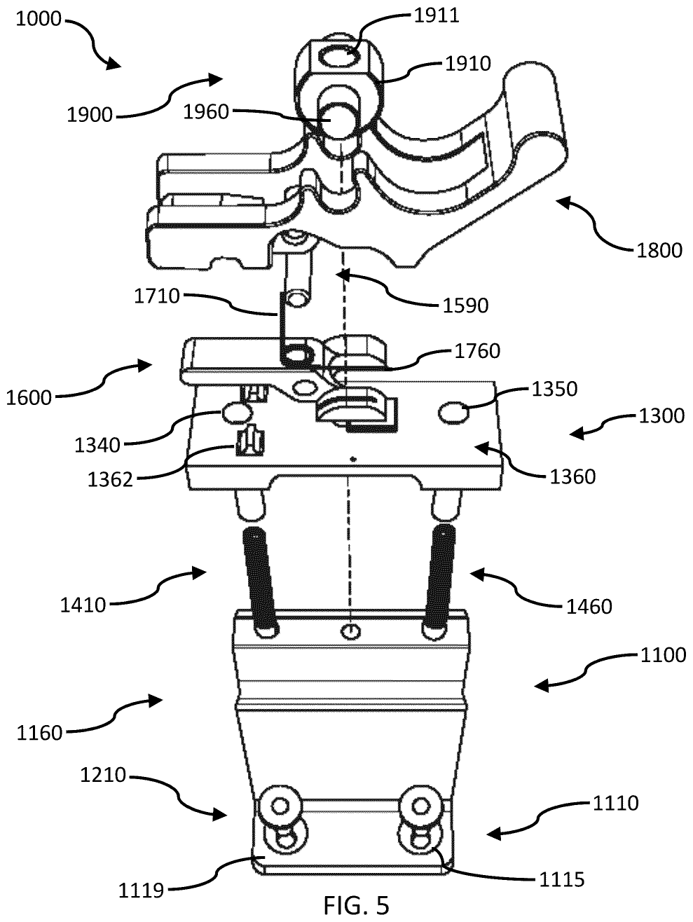

Clamp 1300 is configured for coupling with clamp base 1100 for limited, constrained and/or restricted translation relative thereto and includes a lower, inferior surface or clamping surface 1320 (FIG. 4) and an upper, superior bearing surface 1360 (FIG. 5). Clamping surface 1320 and bearing surface 1360 extend from first end 1310 to second end 1390. Clamp 1300 is restricted to translation by pins, dowels or rails received through both clamp 1300 and clamp base 1100 and translation of clamp 1300 relative to clamp base 1100 is limited in distance by knuckle 1900.

A groove 1321 having a length extending between first and second ends 1310 and 1390 is formed in clamping surface 1320. In an example, groove 1321 is disjoint or interrupted between first and second ends 1310 and 1390. An inner chamfered surface 1329 is provided adjacent to groove 1321 and configured for engaging chamfered surface 1163. Inner chamfered surface 1329 may be provided at any of a variety of angles suitable for mating with chamfered surface 1163. An arch 1327 with a center of curvature located on an axis approximately transverse to the length of disjoint groove 1321 may be formed in clamping surface 1320.

One or more plateaus 1361 (FIG. 6) may be formed on bearing surface 1360 and configured for receipt in a central, forked portion or region of toggle 1800 to restrict swivelling of the toggle to a particular location and/or about a particular axis. For example, rotation of toggle 1800 about an axis parallel with central bore 1330 may be restricted. While plateau 1361 has been shown as rectangular, it may be formed in any of a variety of shapes suitable for internally restricting motion of a component surrounding the plateau.

Clamp 1300 may further include one or more peaks 1362 and 1365 provided to bearing surface 1360. In an example, peaks 1362 and 1365 are aligned along a line parallel with either or both of the first and second ends 1310 and 1390 of clamp 1300. Peaks 1362 and 1365 may be configured to limit translation of one or more feet of latch 1600 with upright surfaces. The upright surfaces may take any of a variety of shapes including but not limited to curved as with a filleted cantilever projecting from bearing surface 1360. In an example, the upright surfaces may curve through arcs of about 90 degrees so as to be generally quarter-circular.

A central through-hole 1330 (FIG. 4) extends through upper and lower surfaces 1360 and 1320 so as to be adjacent to or partially penetrate plateau 1361. Adjacent first end 1310, a first side through-hole 1340 extends through upper and lower surfaces 1360 and 1320 in a direction approximately parallel with central through-hole 1330. Adjacent second end 1390, a second side through-hole 1350 penetrates through upper and lower surfaces 1360 and 1320 in a direction approximately parallel with central through-hole 1330.

With an approximately parallel relationship between the directions of the side through-hole 1340 and 1350 and central through-hole 1330, angles between the through-holes are sufficiently small so as to enable unrestricted motion of coupled components along the respective directions. For example, pins or fasteners placed into the through-hole would be suitably aligned to allow unimpeded relative translation between clamp 1300 and clamp base 1100. In an example, first side through-hole 1340 and second side through-hole 1350 are formed through clamp 1300 to either side of arch 1327 and adjacent to inner chamfered surface 1329.

Clamp 1300 may be formed from any of a variety of rigid, durable materials including but not limited to forged metal, forged aluminum, injection molded plastic or rubber.

A first dowel, pin or pivot 1510 is configured for receipt at least through first side through-hole 1340 of clamp 1300 and may also be partially received through first side bore 1167 of clamp base web 1160. A second dowel, pin or pivot 1560 is configured for receipt at least through second side through-hole 1350 of clamp 1300 and may also be partially received through second side bore 1168 of clamp base web 1160. First dowel pin 1510 and second dowel pin 1560 may contribute to aligning clamp 1300 with clamp base 1100 and may take any of a variety of forms including but not limited to roll pins, stock pins, bolts or other suitable pivoting means.

A first resilient member 1410 is configured for receipt through first side bore 1167 of clamp base web 1160 and/or through first side through-hole 1340 of clamp 1300 and/or around first dowel pin 1510. A second resilient member 1460 is configured for receipt through second side bore 1168 of clamp base web 1160 and/or through second side through-hole 1350 of clamp 1300 and/or around second dowel pin 1560. First resilient member 1410 and second resilient member 1460 may take any of a variety of forms suitable for contributing to biasing clamp 1300 away from clamp base 1100 including but not limited to compression springs.

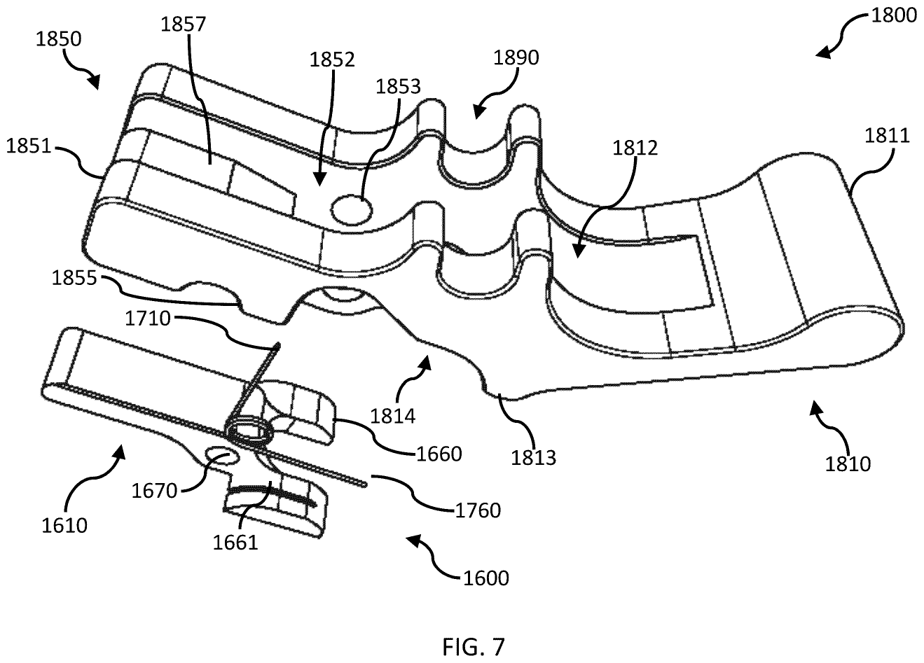

Toggle 1800 (FIGS. 7 & 8) includes a first wing 1810 extending from a forked, proximal or medial portion 1812 to a rounded distal end 1811 and a second wing 1850 extending at an angle to first wing 1810 from a forked proximal or medial portion 1852 to a distal end 1851. In an example, second wing 1850 extends at an angle of approximately 135 degrees to first wing 1810. Forked portion 1812 and forked portion 1852 may be conjoined to provide a window through toggle 1800. A camming pivot 1813 may be provided on each branch of the fork 1812/1852 and a scoop 1814 may be provided adjacent to each pivot 1813. A seat 1857 may be formed between branches of forked region 1852 of second wing 1850.

A yoke 1890 at the join of forks 1812 of first wing 1810 with forks 1852 of second wing 1850 is configured to receive one or more pins or pin arms of knuckle 1900. Yoke 1890 may include two branches corresponding with the two branches of the forked portions 1812/1852 and generally framing a window formed through toggle 1800. A through-hole 1853 is formed through forked portion of second wing 1850 and is configured to receive a dowel, pin or pivot which may span branches of forked portion 1852 of second wing 1850.

A recessed face 1854 may surround through-hole 1853 on a side of one of forks 1852 to accommodate one or more other components adjacent to toggle 1800 and/or to create a space for a spring arm slot 1856 formed adjacent thereto. A semi-circular bore or half-bore 1855 may extend through the second wing 1850 approximately parallel with the through-hole 1853 and may be of suitable shape or dimension to house or otherwise accommodate peaks 1362 and 1365 of clamp 1300. For example, the distance peaks 1362 and 1365 project away from bearing surface 1360, may be less than the radius or radius of curvature of half-bore 1855. Toggle 1800 may be formed from any of a variety of rigid, durable materials including but not limited to forged metal, forged aluminum, injection molded plastic or rubber.

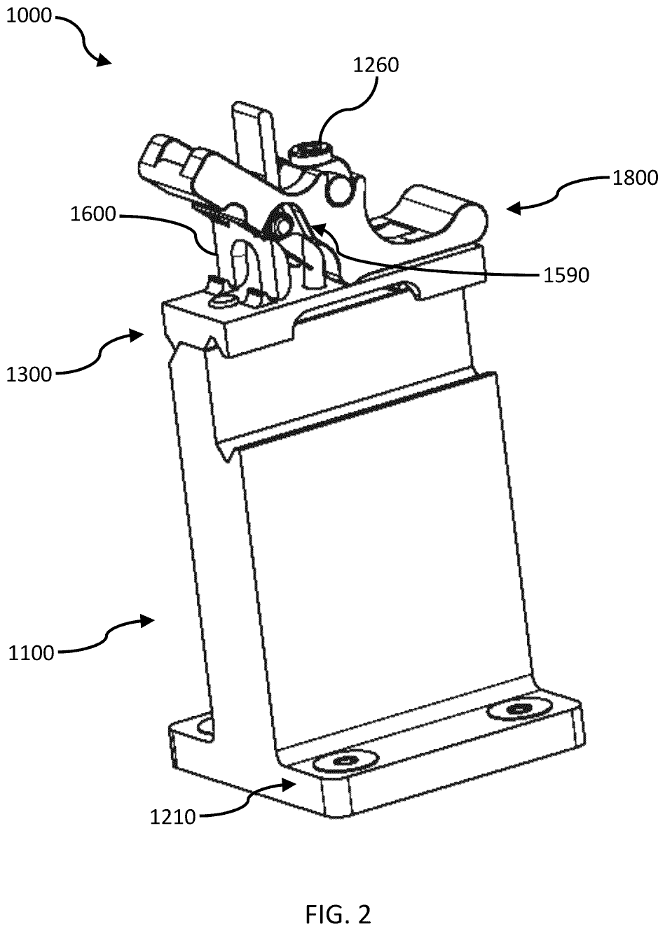

Toggle 1800 may pivot relative to clamp 1300 on the one or more camming pivots 1813 about a first axis between first and second positions or angles. In the first position and/or at the first angle, first wing 1810 contacts clamp 1300 at bearing surface 1360 and the clamp is spaced from clamp base 1100 by a first distance (FIG. 1). In the second position and/or at the second angle, second wing 1850 contacts clamp 1300 at bearing surface 1360 and the clamp is spaced from clamp base 1100 by a second distance greater than the first distance (FIG. 2). Pivoting toggle 1800 toward the first relative position may move or urge the clamp 1300 towards clamp base 1100 while pivoting toggle 1800 toward the second relative position may allow movement of clamp 1300 away from clamp base 1100.

Gripping system 1000 further includes, configured for coupling with toggle 1800 so as to pivot about a second axis spaced apart from the first axis, a latch 1600 having a tongue 1610 and one or more feet 1620 and 1630 at the base of the tongue defining a fork or yoke space 1640. Feet 1620 and 1630 may include flat bottom or lower surfaces 1650 and curved upper surfaces 1660. A through-hole 1670 through a base of tongue 1610 is configured to receive a third pin, dowel or pivot for pivotably coupling latch 1600 with toggle 1800 and defining the second axis. At a first angle of pivot about the second axis, latch 1600 may be configured to prevent and/or lock against pivoting of toggle 1800 relative to clamp 1300 about the first axis. Pivoting of toggle 1800 about the first axis may change the position of the second axis. Latch 1600 may be formed from any of a variety of rigid, durable materials including but not limited to forged metal, forged aluminum, injection molded plastic or rubber.

Third dowel 1590 is configured for receipt through through-holes 1670 and 1853 to pivotably couple latch 1600 to toggle 1800. A slot 1661 formed in an upper surface of one of feet 1620 and 1630 may accommodate a portion of a resilient member such as an arm of a torsion spring. The tongue 1610 may be received through forked portion 1852 between the fork branches of second wing 1850. Tongue 1610 is configured for selective placement against seat 1857 of toggle 1800 so that, with the latch 1600 pivoted to a locked angle about the second axis, the tongue is pivoted away from toggle seat 1867 and, with latch 1600 pivoted to an unlocked angle about the second axis, the tongue is adjacent to or contacts toggle seat 1857.

The one or more feet 1620 and 1630 may contact clamp 1300 and be configured to translate relative thereto while pivoting. Flat bottom or lower surfaces 1650 of feet 620 and 1630 may be generally flush against bearing surface 1360 of clamp 1300 and/or achieve maximum contact area therewith while latch 1600 is at a first predefined, unlocked orientation relative to clamp 1300 (FIG. 1). Also, curved upper surfaces 1660 may be received in, engaged with and/or in contact with scoops 1814.

Flat bottom or lower surfaces 1650 of feet 1620 and 1630 may be generally angled against the bearing surface 1360 of the clamp 1300 and/or achieve minimum contact area therewith while latch 1600 is at a second predefined, locked orientation relative to the clamp 1300. Curved upper surfaces 1660 of the one or more latch feet 1620 and 1630 are configured to disengage from the one or more scoops 1814 of toggle 1800 with latch 1600 at the second predefined, locked orientation or angle about the second axis. First and second peaks 1362 and 1365 may limit translation of feet 1620 and 1630 on bearing surface 1360 of clamp 1300 to thereby limit pivoting of tongue 1610 away from toggle 1800 and/or clamp 1300.

At a first pivot angle, the toggle 1800 is configured to space clamp 1300 from knuckle 1900 by a first distance and, at a second pivot angle, toggle 1800 is configured to space clamp 1300 from knuckle 1900 by a second distance greater than the first distance.

Resilient member 1700 (FIGS. 3-5, 7, 8) is configured to bias toggle 1800 and latch 1600 to a first, locked, relative pivot angle (FIG. 2). A first arm 1710 is configured for receipt within spring arm slot 1856 of the toggle 1800. A second arm 1760 is configured for receipt within a spring arm 1661 slot in the upper surface of at least one of the feet 1620 and 1630. In an example, resilient member 1700 is a torsion spring.

Through a force provided by resilient member 1700, pivoting of toggle 1800 about the first axis from a position wherein second wing 1850 contacts bearing surface 1360 to a position wherein first wing 1810 contacts clamp upper surface 1360 is configured to further cause pivoting of latch 1600 relative to clamp 1300 about the second axis to a locked condition in which it prevents pivoting of toggle 1800 back to the position wherein second wing 1850 contacts bearing surface 1360 and grooves 1164 and 1321 are spaced so as to release an object or rail from therebetween.

A knuckle 1900 (FIG. 5) includes a main body 1910, a central through-hole 1911 and a dowel, pin or pivot 1960 extending from main body 1910. Dowel 1960 is approximately perpendicular with central through-hole 1911 and is interrupted thereby, to yield first and second ends or dowel arms extending in opposite directions from main body 1910 and configured for receipt within yoke 1890 of toggle 1800. In an example, dowel 1960 is formed integral with main body 1910. Knuckle 1900 may be formed from any of a variety of rigid, durable materials including but not limited to forged metal, forged aluminum, injection molded plastic or rubber.

A lag screw 1260 (FIG. 4) is configured for receipt through central through-hole 1911 of knuckle 1900, toggle 1800, latch 1600, central through-hole 1330 of clamp 1600 and central bore 1165 of clamp base web 1160. With lag screw 1260 inserted through central through-hole 1911, between forked regions 1812 and 1852 of toggle 1800, through yoke space 1640 of latch 1600, through central through-hole 1330 of clamp 1300, and into central bore 1165 of clamp base web 1165 such that central bore 1911, forked regions 1812 and 1852 of toggle 1800, yoke space 1640 of latch 1600, and central bore 1330 of clamp 1300 surround an unthreaded length of lag screw 1260 and may slide relative thereto while internal threads of central bore 1162 grip an externally threaded length of lag screw 1260 preventing pure relative translation of the lag screw 1260 relative to clamp base 1100. With lag screw 1260 inserted through knuckle 1900 and into clamp base 1100 toggle 1800, latch 1600 and clamp 1300 are squeezed between knuckle pin arms 1930 received in yoke 1890 and resilient members 1410 and 1460.

Rotation of lag screw 1260 a first direction adjusts the distance between clamp 1300 and clamp base 1100 to be less in the default or unlocked position such that actuation of toggle 1800 and/or latch 1600 to the locked position yields a tighter grip between clamp 1300 and clamp base 1100 and/or between groove 1321 and groove 1164. Rotation of lag screw 1260 in a second direction adjusts the distance between clamp 1300 and clamp base 1100 to be greater in the default or unlocked position such that actuation of toggle 1800 and/or latch 1600 to the locked position yields a looser grip between clamp 1300 and clamp base 1100 and/or between groove 1321 and groove 1164.

To prevent unauthorized separation of gripping system 1000 from an object such as a rail of a firearm 2000, a locking bar or rod may be placed between latch 1600 and lag screw 1260 and/or toggle 1800 in the locked position when the latch is pivoted to an angle relative to clamp 1300. So placed, the locking bar will bind between latch 1600 and lag screw 1260 and/or toggle 1800 and prevent pivoting latch 1600 back to an unlocked position with tongue 1610 contacting or adjacent to seat 1857

Disclosed gripping systems may be suitable for use in a variety of methods for latching and/or gripping objects including but not limited to gripping or latching firearms by a rail provided thereto.

With the clamp at a first spacing from the clamp base, a firearm rail is inserted between a lower groove of the clamp and an upper groove of the clamp base. The curved end of the first wing is pressed towards the upper surface of the clamp. As the first wing pivots with the cam surfaces on the clamp upper surface about a first axis, the second wing pivots away from the upper surface of the clamp. In an example, the first axis is defined through the center of the dowel or dowels of a knuckle. In response to pressure from a biasing member such as a torsion spring, the latch pivots about a second axis to a position wherein the tongue is disengaged from the seat and the feet are translated across the clamp upper surface while pivoting. In an example, the second axis is defined through the center of the dowel coupling the latch with the toggle.

Further, the clamp moves towards the clamp base against the bias of one or more compression springs. Pivoting of the toggle continues until the first wing contacts the upper suface and the lower groove of the clamp and the upper groove of the clamp base grip the rail. Pivoting of the latch is limited by engagement of one or more of the feet with one or more peaks provided to the upper surface of the clamp.

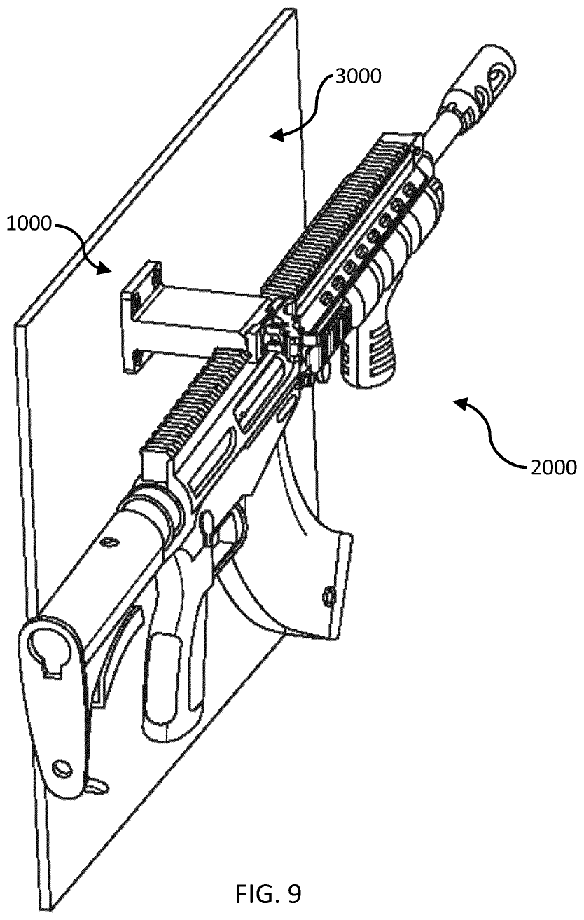

FIG. 9 illustrates an example gripping system 1000 in use for mounting an example firearm 2000 to a support surface 3000 which may be oriented vertically, horizontally or at an oblique angle.

In order to remove a firearm from the gripping system, with the firearm rail gripped between the grooves, the tongue of the latch is pressed to rotate the latch against the force of the biasing member toward the upper surface of the clamp. Once the tongue engages with the seat of the toggle, continued pressure on the tongue causes rotation of both the latch and the toggle together to pivot the second wing until it contacts the upper surface of the clamp. As the second wing is rotated towards the upper surface of the clamp, spacing between the clamp and the clamp base increases to release grip on the firearm rail.

Embodiments of the disclosure are susceptible to being used for various purposes, including, though not limited to, enabling users to store an item such as a firearm safely and securely without damage or movement thereof.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim the disclosure are intended to be construed in a non-exclusive manner, namely allowing for items, components or elements not explicitly described also to be present. Reference to the singular is also to be construed to relate to the plural.

What is claimed is:

1. A gripping system, comprising:
a clamp base having a flange and a web extending from a proximal end at the foot to a distal end;
a clamp coupled with the clamp base for limited translation relative thereto;
coupled with the clamp so as to pivot about a first axis, a toggle having a central, forked portion, a seat and one or more camming pivots; and
coupled with the toggle so as to pivot about a second axis spaced apart from the first axis, a latch having one or more feet contacting the clamp and a tongue received through the forked portion for selective placement against the seat of the toggle.

2. The gripping system as set forth in claim 1, wherein, at a first angle of pivot about the second axis, the latch prevents pivoting of the toggle relative to the clamp about the first axis.

3. The gripping system as set forth in claim 1, wherein the toggle pivots relative to the clamp on the one or more camming pivots between a first position in which a first wing contacts the clamp and a second position in which a second wing contacts the clamp.

4. The gripping system as set forth in claim 1, wherein the toggle pivots relative to the clamp on the one or more camming pivots between a first position in which the clamp is spaced from the clamp base by a first distance to a second position in which the clamp is spaced from the clamp base by a second distance less than the first distance.

5. The gripping system as set forth in claim 1, further comprising at least one resilient member biasing the clamp away from the clamp base.

6. The gripping system as set forth in claim 1, further comprising a resilient member biasing the latch to a first pivot angle relative to the toggle.

7. The gripping system as set forth in claim 1, wherein the toggle further comprises, cradling first and second dowel arms of a knuckle having a body from which the first and second dowel arms extend, a yoke cradling the first and second dowel arms.

8. The gripping system as set forth in claim 7, further comprising a fastener received through a central through-hole in the body of the knuckle, through the toggle, through the latch and into a central bore of the clamp base.

9. A gripping system, comprising:
a clamp base having a flange and a web extending from a proximal end at the flange to a distal end;
a clamp coupled with the clamp base for limited translation relative thereto;
coupled with the clamp so as to pivot about a first axis, a toggle having a central, forked portion, one or more camming pivots and a seat; and
a knuckle having a body and first and second dowel arms extending therefrom and, wherein the toggle further comprises a yoke cradling the first and second dowel arms;
a fastener received through a central through-hole in the body of the knuckle, through the toggle, through the latch and into a central bore of the clamp base;
wherein at a first pivot angle, the toggle is configured to space the clamp from the knuckle by a first distance and, at a second pivot position, the toggle is configured to space the clamp from the knuckle by a second distance greater than the first distance.

10. The gripping system a set forth in claim 9, further comprising, coupled with the toggle so as to pivot about a second axis spaced apart from the first axis, a latch having one or more feet contacting the clamp and a tongue received through the forked portion for selective placement against the seat of the toggle.

11. The gripping system as set forth in claim 10, wherein curved upper surfaces of the one or more latch feet are configured to mate with one or more scoops of the toggle with the latch pivoted to an unlocked angle about the second axis.

12. The gripping system as set forth in claim 10, wherein curved upper surfaces of the one or more latch feet are configured to disengage from one or more scoops of the toggle with the latch pivoted to a locked angle about the second axis.

13. The gripping system as set forth in claim 10, wherein the latch tongue is configured to be pivoted away from the toggle seat with the latch pivoted to a locked angle about the second axis.

14. A gripping system, comprising:
a clamp base having a flange and a web extending from a proximal end at the foot to a distal end;
a clamp coupled with the clamp base for limited translation relative thereto;
configured for coupling with the clamp so as to pivot about a first axis, a toggle having a central, forked portion, a seat and one or more camming pivots; and
configured for coupling with the toggle so as to pivot about a second axis spaced apart from the first axis, a latch having one or more feet configured to translate relative to the clamp and a tongue configurd for receipt through the forked portion and selective placement against the seat of the toggle.

15. The gripping system as set forth in claim 14, wherein, at a first angle of pivot about the second axis, the latch is configured to prevent pivoting of the toggle relative to the clamp about the first axis.

16. The gripping system as set forth in claim 14, further comprising a resilient member biasing the latch to a first pivot position relative to the toggle.

17. The gripping system as set forth in claim 14, further comprising a fastener configured to couple the toggle with the clamp.

18. The gripping system as set forth in claim 14, further comprising at least one resilient member configured to bias the clamp away from the clamp base.

19. The gripping system as set forth in claim 14, further comprising a resilient member configured to bias the latch to a first pivot position relative to the toggle.

20. The gripping system as set forth in claim 14, further comprising a knuckle having a body and first and second dowel arms extending therefrom and, wherein the toggle further comprises a yoke configured to cradle the first and second dowel arms.

21. The gripping system as set forth in claim 20, further comprising a fastener configured for receipt through a central through-hole in the body of the knuckle, through the toggle, through the latch and into a central bore of the clamp base.
